(19) United States
(12) Patent Application Publication
(10) Pub. No.: US 2008/0286153 A1
(43) Pub. Date: Nov. 20, 2008

(54) Affinity Chromatography Microdevice and Method for Manufacturing the Same

(75) Inventors: Dae-Sik Lee, Daejon (KR); Hyun-Cheol Yoon, Seoul (KR); Kwang-Hyo Chung, Daejon (KR); Hyeon-Bong Pyo, Daejon (KR); Chang-Auck Choi, Daejon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejon (KR)

(21) Appl. No.: 12/094,980

(22) PCT Filed: Nov. 27, 2006
(86) PCT No.: PCT/KR2006/005022

§ 371 Date: May 23, 2008

(30) Foreign Application Priority Data
Nov. 30, 2005 (KR) 10-2005-0115897
Jun. 20, 2006 (KR) 10-2006-0055481

(51) Int. Cl. G01N 30/02; B05D 3/14

(52) U.S. Cl. 422/70; 427/58

(57) ABSTRACT

An affinity chromatography microdevice includes a top board and a bottom board. The top board includes an inlet and an outlet through which microfluid flows, and a reaction chamber for limiting the flow of the microfluid for reaction. The bottom board includes a microelectrode for independently controlling a micro-temperature, and a thermosensitive polymer matrix formed on the microelectrode. The thermosensitive polymer matrix is contracted or expanded according to temperature change.

### TECHNICAL FIELD

The present invention relates to an affinity chromatography microdevice and a method for manufacturing the same.

### BACKGROUND ART

A specific target material having biologic activity is selectively combined by affinity against a specific capture material, just like an enzyme-substrate reaction. The affinity chromatography separates and refines only target materials using the affinity. Specifically, a capture material that can be selectively combined with a desired target material is bonded with an insoluble support, thereby forming a complex. The complex is filled into a pipe and a reagent flows through the complex. As a result, only the target material that can be selectively combined with the capture material remains, while the materials having no affinity are eluted. Since the affinity chromatography separates and refine materials having biologic activity, many efforts have been made to develop bio-information sensing devices that can sense diseases simply and conveniently.

In bio-MEMS fields, many microfabricated temperature control devices have been introduced in association with PCR or thermal cycling. The temperature control devices must enhance thermal isolation around a reaction chamber in order for precise temperature control and must reduce thermal crosstalk between the reaction chambers or between the reaction chamber and a substrate where electronic components are integrated. The present inventors invented a microfabricated thermal cycling device, which is disclosed in Korean Patent Publication No. 10-0452946. In this patent, a silicon substrate is used as a bottom board and a bottom surface of the bottom board is etched to form the micro-fabricated thermal cycling device.

Although the micro-fabricated thermal cycling device can control temperature precisely, it is difficult to control the reaction between the target material and the capture material according to temperature.

Moreover, it is difficult to selectively separate and refine a plurality of biomaterials.

### DISCLOSURE OF INVENTION

Technical Problem

It is, therefore, an object of the present invention to provide an affinity chromatography microdevice which can easily control the reaction between a target material and a capture material according to temperature, and a method for fabricating the same.

It is another object of the present invention to provide an affinity chromatography microdevice suitable for selectively separating and refining a plurality of biomaterials, and a method for fabricating the same.

Technical Solution

In accordance with one aspect of the present invention, there is provided an affinity chromatography microdevice including: a top board including an inlet and an outlet through which microfluid flows, and a reaction chamber for limiting the flow of the microfluid for reaction; and a bottom board including a microelectrode for independently controlling a micro-temperature, and a thermosensitive polymer matrix formed on the microelectrode, the thermosensitive polymer matrix being contracted or expanded according to temperature change. The thermosensitive polymer matrix may be a poly N-isopropylacrylamide (PNIPAAm). The PNIPAAm has a hydrophilic extended-chain structure below a predetermined temperature and forms a hydrophobic contracted-chain structure above the predetermined temperature. Therefore, the capture material can easily react with the target material above the predetermined temperature.

The bottom board may further include a surface treatment material such as a self assembled monolayer (SAM). Also, the bottom board may further include an immobilization material such as a dendrimer.

In accordance with another embodiment of the present invention, there is provided an affinity chromatography microdevice including: a top board including an inlet and an outlet through which microfluid flows, and a plurality of reaction chambers for limiting the flow of the microfluid for reaction; and a bottom board including a microelectrode array having a plurality of microelectrode for independently controlling a micro-temperature, and a thermosensitive polymer matrix formed on the microelectrode array, the thermosensitive polymer matrix being contracted or expanded according to temperature change.

In a further another aspect of the present invention, there is provided a method for manufacturing an affinity chromatography microdevice, including the steps of: a) preparing a bottom board including a microelectrode for independently controlling a micro-temperature, and a thermosensitive polymer matrix formed on the microelectrode, the thermosensitive polymer matrix being contracted or expanded according to temperature change; b) preparing a top board including a reaction chamber, an inlet, and an outlet; and c) attaching the bottom board to the top board.

The step a) may include the steps of: a1) forming a self assembled monolayer (SAM) on the microelectrode by processing 3,3-dithoiopropionic acid bis-N-hydroxysuccinimide ester (DTSP); a2) forming a dendrimer on the SAM by processing a dendrimer nanostructural solution; and a3) forming the thermosensitive polymer matrix on the dendrimer.

Advantageous Effects

According to the present invention, a thermosensitive polymer matrix is applied to an affinity chromatography microdevice having a good thermal interference reduction characteristic. Therefore, capture material and target material can be easily combined by controlling the temperature of a reaction chamber.

In addition, when a plurality of reaction chambers are arranged, a plurality of bio-materials can be selectively separated and refined.

### BRIEF DESCRIPTION OF THE DRAWINGS

The above and other objects and features of the present invention will become apparent from the following description of the preferred embodiments given in conjunction with the accompanying drawings, in which:

FIG. 1 is a perspective view of an affinity chromatography microdevice in accordance with an embodiment of the present invention;

FIG. 2 is a cross-sectional view of the affinity chromatography microdevice of FIG. 1;

FIG. 3 is a plan view of a top board in the affinity chromatography microdevice of FIG. 1;

FIG. 4 is a sectional view taken along line IV-IV′ of FIG. 3;

FIG. 5 is a plan view of a bottom board in the affinity chromatography microdevice of FIG. 1;

FIG. 6 is a cross-sectional view taken along line VI-VI′ of FIG. 5;

FIG. 7 is a cross-sectional view of the bottom board in the affinity chromatography microdevice of FIG. 1;

FIG. 8 is a cross-sectional view illustrating an operation principle of a thermosensitive polymer matrix in the affinity chromatography microdevice;

FIGS. 9 to 13 are cross-sectional views illustrating how a capture material of the affinity chromatography microdevice reacts with a target material;

FIG. 14 is a picture illustrating the result of the reaction between the capture material and the target material;

FIGS. 15 and 16 are cross-sectional views illustrating how the capture material of the affinity chromatography microdevice reacts with the target material according to temperature;

FIGS. 17 to 20 are cross-sectional views illustrating a method for manufacturing a top board of the affinity chromatography microdevice in accordance with an embodiment of the present invention;

FIGS. 21 to 24 are cross-sectional views illustrating a method for manufacturing a top board of the affinity chromatography microdevice in accordance with another embodiment of the present invention;

FIGS. 25 to 29 are cross-sectional views illustrating a method for manufacturing a bottom board of the affinity chromatography microdevice in accordance with an embodiment of the present invention;

FIG. 30 is a cross-sectional view of the affinity chromatography microdevice in accordance with an embodiment of the present invention; and

FIG. 31 is a perspective view of the affinity chromatography microdevice in accordance with an embodiment of the present invention.

### BEST MODE FOR CARRYING OUT THE INVENTION

Other objects and aspects of the invention will become apparent from the following description of the embodiments with reference to the accompanying drawings, which is set forth hereinafter.

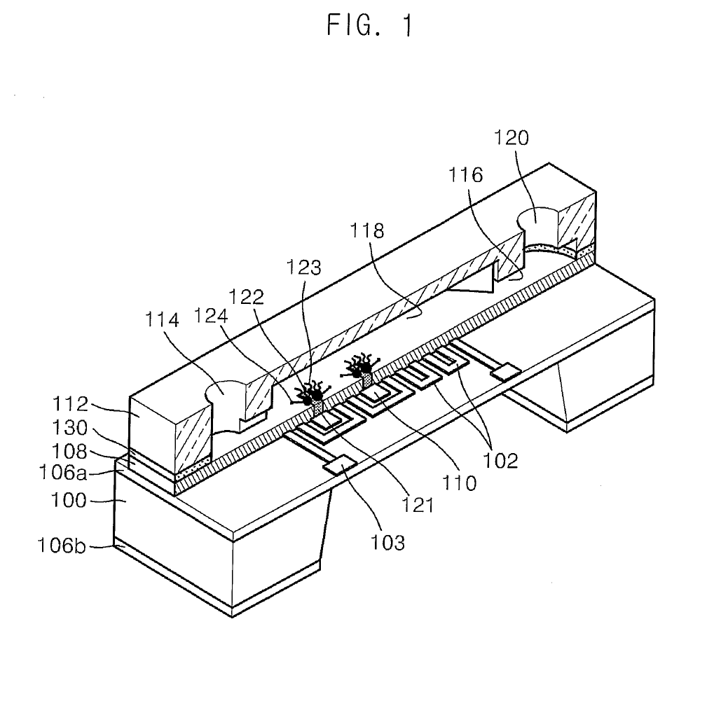

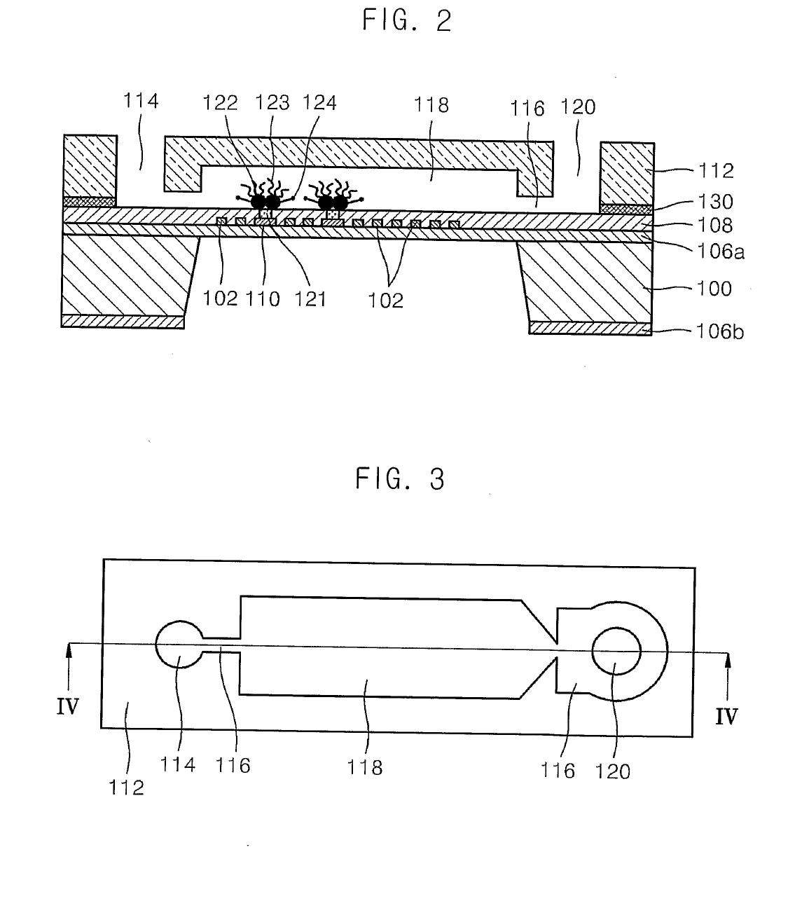

FIG. 1 is a perspective view of an affinity chromatography microdevice in accordance with an embodiment of the present invention, and FIG. 2 is a cross-sectional view of the affinity chromatography microdevice of FIG. 1.

Referring to FIGS. 1 and 2, the affinity chromatography microdevice includes a top board and a bottom board.

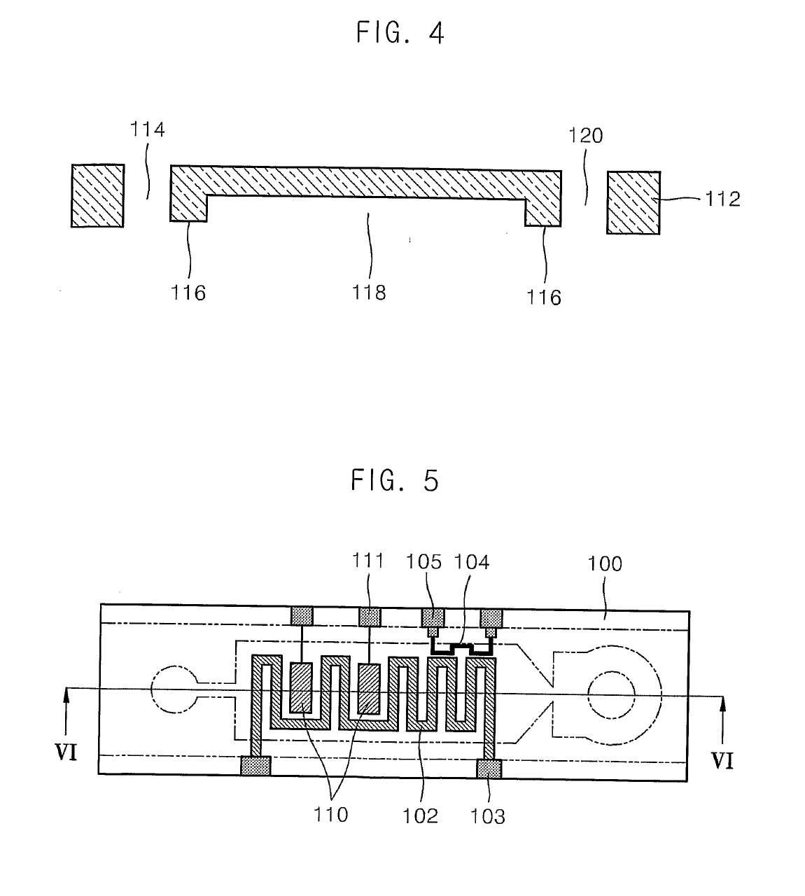

The bottom board includes an insulating heating thin film 106a, a heater 102, a temperature sensor (104 in FIG. 5), a microelectrode 110, an insulating layer 108, a PNIPAAm 123, and a capture material 124. The insulating heating thin film 106a is formed by etching a predetermined rear portion of a substrate and is thermally isolated from a peripheral portion. The heater 102 is formed on the insulating heating thin film 106a to heat a reaction chamber 118. The temperature sensor (104 in FIG. 4) is formed on the insulating heating thin film 106a to sense a temperature of the reaction chamber 118. The microelectrode 110 is formed on the insulating heating thin film 106a to sense a bonding of a target material. The insulating layer 108 surrounds the heater 102 and the temperature sensor (104 in FIG. 4). The PNIPAAm 123 is a thermosensitive polymer matrix and is formed on the microelectrode 110. The PNIPAAm 123 is contracted or expanded according to temperature change. The capture material 124 captures the target material.

The bottom board may include the insulating heating thin film 106a and an insulating layer 106b that are formed on top and bottom surfaces of a first substrate 100, respectively. The first substrate 100 is formed of plastic or silicon. The heater 102, the temperature sensor (104 in FIG. 4), and the microelectrode 110 include electrode lines and electrode pads 103 (105 and 111 in FIG. 5). The electrode lines are formed on the insulating heating thin film 106a by patterning a conductive layer, and the electrode pads 103 (105 and 111 in FIG. 5) are formed on the outside of the bottom board and are connected to the electrode lines.

A surface treatment material 121 may be provided on the microelectrode 110. An immobilization material 122 may be provided on the surface treatment material 121 in order to increase adsorption site between the PNIPAAm 123 and the capture material 124. The surface treatment material 121 includes SAM and the immobilization material 122 includes dendrimer.

The top board includes an inlet 114, a reaction chamber 118, and an outlet 120 on a second substrate 112 formed of silicon or plastic. Microfluid flows through the inlet 114, the reaction chamber 118, and the outlet 120. The inlet 114 is a portion where a solution is introduced, a passage 116 is a portion where the introduced solution moves, the reaction chamber 118 is a portion where the solution reacts, and the outlet 120 is a portion where the solution is discharged after the reaction.

The top board and the bottom board are bonded with each other. It is preferable that adhesive is applied on the bonded portion 130 in order to prevent the introduced solution from being discharged to the outside through the bonded portion 130.

FIG. 3 is a plan view of the top board in the affinity chromatography microdevice of FIG. 1, and FIG. 4 is a sectional view taken along line IV-IV′ of FIG. 3.

Referring to FIG. 3, the top board includes the inlet 114 and the outlet 120 where the solution is introduced and discharged, and the reaction chamber 118 where the solution is received for reaction. The passage 116 is a portion where the solution moves. The top board may further include a flow stopper at an end portion of the reaction chamber 118 near the outlet 120, so that the solution can react sufficiently. The flow stopper may be formed using an abrupt outlet expansion portion at the end portion of the reaction chamber 118. Even though the flow stopper is not separately formed on the top board, the fluid flow can be restricted by forming hydrophobic pads on the bottom board corresponding to the passage 116 or the reaction chamber 118 near the outlet 120.

The second substrate 112 may be formed of at least one of polymer, metal, silicon, quartz, elastic material, ceramic, printed circuit board (PCB), and combination thereof. Examples of the polymer include polymethylmethacrylate (PMMA), polycarbonate (PC), cyclo olefin copolymer (COC), cyclo olefin polymer (COP), liquid crystalline polymers (LCP), polydimethylsiloxane (PDMS), polyamide (PA), polyethylene (PE), polyimide (PI), polypropylene (PP), polyphenylene ether (PPE), polystyrene (PS), polyoxymethylene (POM), polyetheretherketone (PEEK), polytetrafluoroethylene (PTFE), polyvinylchloride (PVC), polyvinylidene fluoride (PVDF), polybutyleneeterephthalate (PFA), fluorinated ethylenepropylene (FEP), and perfluoralkoxyalkane (PFA). Examples of the metal include aluminum, copper, and iron.

When the second substrate 112 is formed of plastic, evaporation of the reaction fluid occurs seriously at high temperature. In order to prevent this evaporation, a glass coating layer may be further formed on inner walls of the passage 116 and the reaction chamber 18.

As illustrated in FIG. 4, the solution containing the target material is transferred to through the inlet 114 and the passage 116 to the reaction chamber 118 and is stopped at the flow stopper formed near the outlet 120. After the reaction, a remaining solution is discharged through the outlet 120 to the outside.

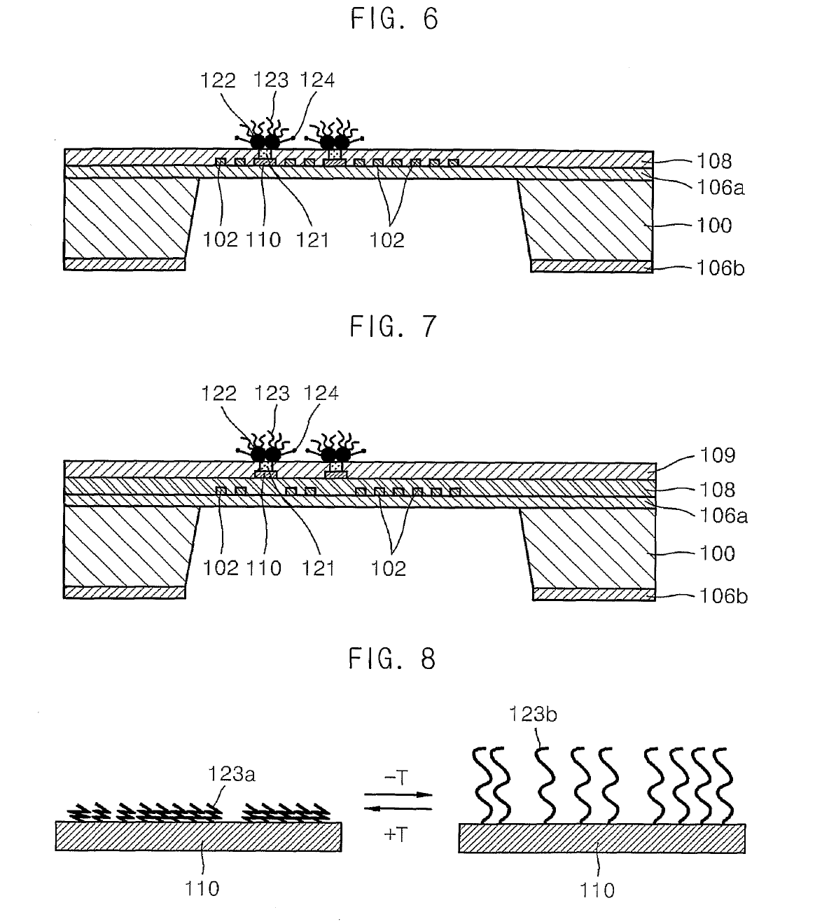

FIG. 5 is a plan view of the bottom board in the affinity chromatography microdevice of FIG. 1, and FIG. 6 is a cross-sectional view taken along line VI-VI′ of FIG. 5.

The insulating layer 108, the SAM 121, the dendrimer 122, the PNIPAAm 123, and the capture material 124 are not shown in FIG. 5 for the purpose of the detailed illustration of metal patterns of the bottom board, i.e., electrode lines. The omitted elements are shown in FIG. 6. A dotted line indicates the top board to be placed on the bottom board. The solution is injected into the reaction chamber 118 defined by the dotted line, and a volume of the injected solution is limited.

Referring to FIG. 5, conductive patterns are formed on the insulating heating thin film 106a. The conductive patterns form the heater 102, the temperature sensor 104, the microelectrode 110, and the electrode pads 103, 105 and 111. The electrode pads 103, 105 and 111 transfer external electric signals to the heater 102, the temperature sensor 104, and the microelectrode 110. The conductive layer for the heater 102 and the temperature sensor 104 may include a monolayer or multilayer formed of one selected from the group consisting of metal such as platinum, gold, aluminum and copper, metal oxide such as RuO , doped polycrystalline silicon, GaAs, polycrystalline SiGe, and ceramic. The microelectrode 110 is used for sensing biochemical material within the reaction chamber 118 and may be formed of metal, e.g., gold or platinum, which is suitable for electrical conductivity, surface treatment, and sensor signal acquisition.

The first substrate 100 may be formed of materials used for the second substrate 112 of the top board. Preferably, the first substrate 100 is formed of silicon or plastic. The insulating heating thin film 116a has a thickness of 0.1 to 10 μm and is formed of one selected from the group consisting of Si₃N₄, phosphosilicateglass (PSG), SiO₂, and combination thereof, e.g., Si₃N₄/SiO₂/Si₃N₄, SiO₂/Si₃N₄/SiO₂, and SiO₂/Si₃N₄/SiO₂/Si₃N₄, Si-added combination, e.g., Si/Si₃N₄, Si₃N₄/Si, Si/SiO₂, SiO₂/Si, Si/Si₃N₄/SiO₂/Si₃NN₄, Si₃N₄/Si/SiO₂/Si₃N₄, Si/SiO₂/Si₃N₄/SiO, SiO₂/Si/Si₃N₄/SiO₂, Si/Si₃N₄/SiO₂/Si₃N₄/SiO₂, and Si/SiO₂/Si₃N₄/SiO₂/Si₃N₄, and polymer, e.g., polymethylmethacrylate (PMMA), polycarbonate (PC), cyclo olefin copolymer (COC), cyclo olefin polymer (COP), polyimide (PI), polystyrene (PS), polyvinylchloride (PVC), liquid crystalline polymers (LCP), and perfluoralkoxyalkane (PFA).

Referring to FIG. 6, the bottom board includes the insulating heating thin film 106a and the insulating layer 106b that are formed on the top and bottom surfaces of the first substrate 100, respectively. Also, the bottom board includes the heater 102, the temperature sensor 104, the microelectrode 110, and the electrode pads 103, 105 and 111 on the insulating heating thin film 106a. Further, the bottom board includes the insulating layer 108 that surrounds the heater 102 and the temperature sensor 104 and exposes the microelectrode 110.

A predetermined portion of the first substrate 100 is formed to expose the insulating heating thin film 106a. More specifically, the heater 102 is formed in the insulating heating thin film 106a, and a predetermined portion of the first substrate 100 under the heater 102 is removed. Then, the insulating layer 106b is formed on the bottom surface of the remaining first substrate 100. The reaction part of the affinity chromatography microdevice can be thermally isolated from the peripheral part effectively by the structure of the first substrate 100, the insulating heating thin film 106a, and the insulating layer 106b.

The insulating layer 108 is thick enough to cover the heater 102 and the temperature sensor 104, and may be formed of materials used for forming the insulting heating thin film 106a.

The bottom board includes the SAM 121, the dendrimer 122, the PNIPAAm 123, and the capture material 124, which are formed on the exposed microelectrode 110.

The microelectrode 110 may contain various chemicals, including surface active agent. It is preferable that the SAM 121 and the dendrimer 122 are contained as a building block for the effective immobilization of the target material. The dendrimer 122 has amine group on its surface and can be hydrated and immobilized by the reaction with the PNIPAAm 123.

FIG. 7 is a cross-sectional view of the bottom board in the affinity chromatography microdevice of FIG. 1.

The bottom board of FIG. 7 is a modification of the bottom board of FIG. 6. The insulating heating thin film 106a and the insulating layer 106b are formed on the top and bottom surfaces of the first substrate 100, respectively, and the heater 102 and the temperature sensor are formed on the insulating heating thin film 106a. The first insulating layer 108 corresponding to the insulating layer of the bottom substrate in FIG. 6 is formed to cover the heater 102 and the temperature sensor 104. The microelectrode 110 is formed on the first insulating layer 108. The second insulating layer 109 is formed to expose the microelectrode 110. In this embodiment, the microelectrode 110, the heater 102, and the temperature sensor 104 are all arranged in the insulating heating thin film 106a. The vertical heat transfer can be achieved more precisely and rapidly by forming the first insulating layer 108 to cover the heater 102 and the temperature sensor 104. The second insulating layer 109 may be formed of the same material as the insulating heating thin film 106a.

FIG. 8 is a cross-sectional view illustrating an operation principle of the thermosensitive polymer matrix in the affinity chromatography microdevice.

Referring to FIG. 8, the PNIPAAm 123 is exemplified as the thermosensitive polymer matrix. The thermosensitive polymer matrix has a hydrophilic chain-extended structure 123b below a lower critical solution temperature (LCST) and has a hydrophobic chain-contracted structure 123a below the LCST. Generally, the LCST of the PNIPAAm 123 is approximately 32° C. in the pure water and is approximately 26° C. in the water-soluble buffer solution. Thus, compared with biomaterial, the PNIPAAm 123 has a relatively stable LCST.

The thermosensitive polymer matrix causes the rapid and reversible change of the hydration/dehydration in the solution dependently on the temperature. Therefore, the thermosensitive polymer matrix reacts sensitively to the slight temperature change around the LCST and changes reversibly. Because the structure of the thermosensitive polymer matrix is changed at the temperature that is easily adjusted, the change of molecules can be easily controlled at the outside.

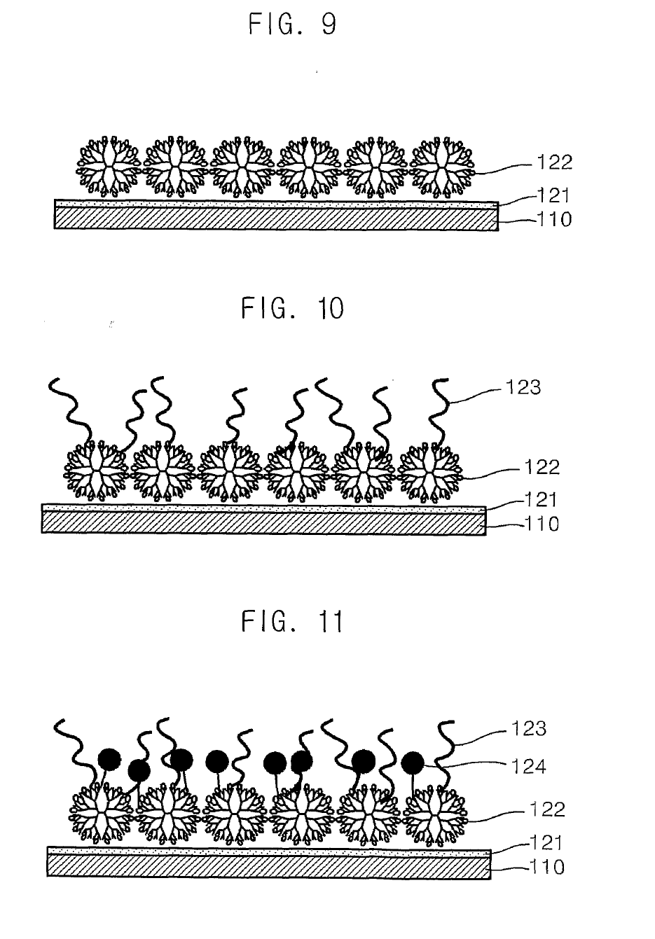

FIGS. 9 to 13 are cross-sectional views illustrating how the capture material reacts with the target material in the affinity chromatography microdevice.

Referring to FIG. 9, the SAM 121 is formed on the microelectrode 110 and the dendrimer 122 is formed on the SAM 121. The SAM 121 is formed for the surface treatment of the microelectrode 110, and the dendrimer 122 is formed in nano-sized particles in order for increasing bonding capability of fine materials such as the capture material and the thermosensitive polymer matrix, or for immobilization by the adsorption into the microelectrode 110. Specifically, it is preferable that the dendrimer 122 uses a poly(amidoamine)dendrimer having amine group on its surface.

Referring to FIG. 10, the PNIPAAm 123 is immobilized on the dendrimer 122. As illustrated in FIG. 8, when the PNIPAAm 123 is used as the thermosensitive polymer matrix, the PNIPAAm 123 can be immobilized using poly(amidoamine)dendrimer.

Referring to FIG. 11, the capture material 124 can be placed on the dendrimer 122.

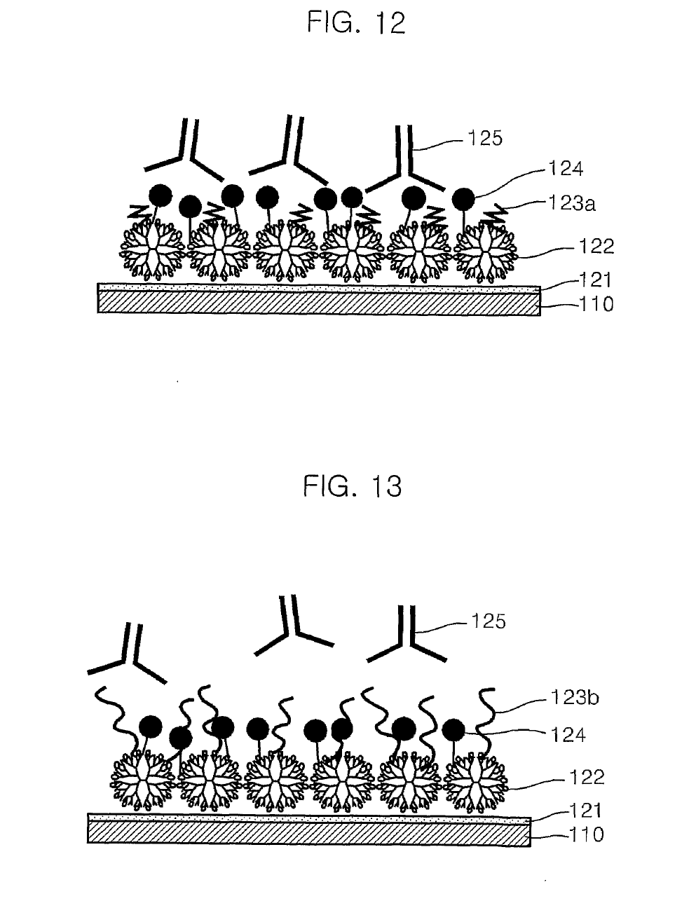

Referring to FIG. 12, the PNIPAAm 123 is contracted above the LCST. Therefore, the capture material 124 reacts with the target material 125 and desired material can be separated or refined.

Referring to FIG. 13, the PNIPAAm 123 is expanded below the LCST. Therefore, the reaction between the capture material 124 and the target material 125 are interrupted.

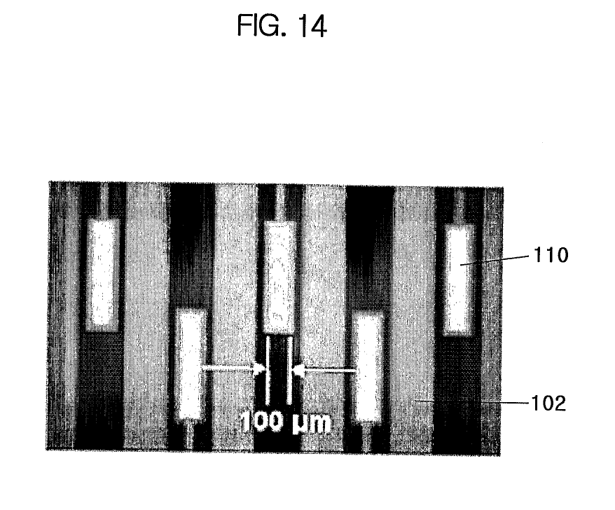

FIG. 14 is a picture illustrating the heater and the microelectrode.

Referring to FIG. 14, the microelectrodes 110 having a width of about 100 μm are arranged, and the heaters 120 are formed around the microelectrodes 110.

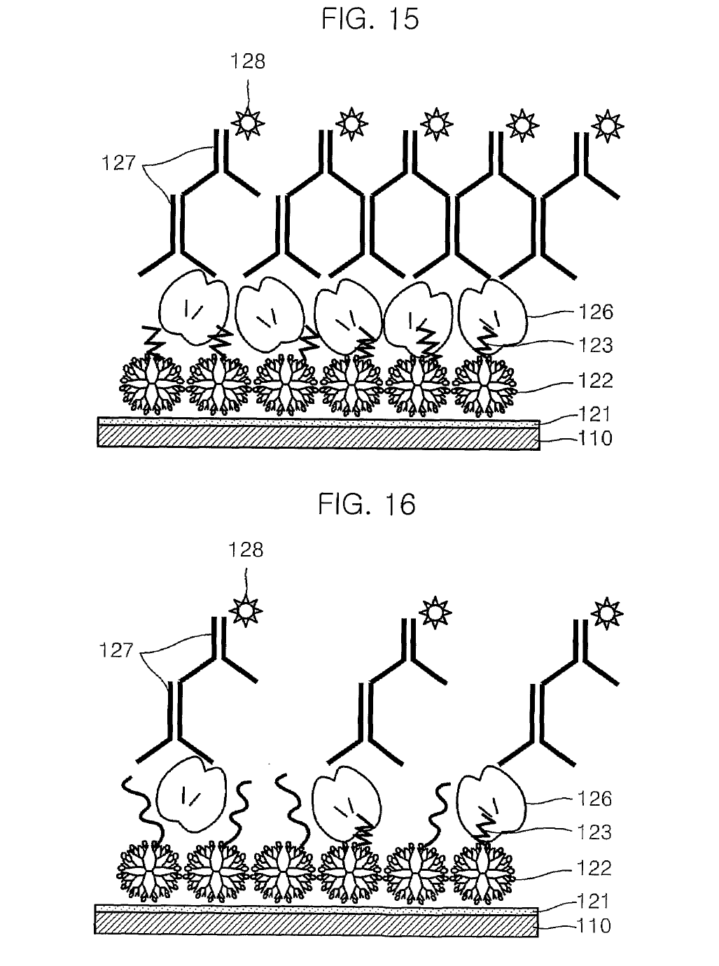

FIGS. 15 and 16 are cross-sectional views illustrating how the capture material reacts with the target material in the affinity chromatography microdevice according to temperature.

Referring to FIG. 15, the SAM 121 and the dendrimer 122 are formed on the microelectrode 110, and the thermosensitive polymer matrix 123 is immobilized on the dendrimer 122. PNIPAAm is used as the thermosensitive polymer matrix 123. The PNIPAAm 123 is contracted above the LCST and a plurality of glucose oxidase (Gox) 126 as the capture material is attached to the dendrimer 122. Then, when the solution containing anti Gox Ig G 127 as the target material is injected, the Gox 126 reacts with the anti Gox Ig G 127 through an antigen-antibody reaction. For inspection, fluorescent bead 128 is attached to the end of the anti Gox Ig G 127.

The PNIPAAm 123 is contracted and a large amount of Gox 126 is attached to the dendrimer 122. Thus, a large amount of the anti Gox Ig G 127 is immobilized. The fluorescent picture of the shape of the microelectrode 110 can be seen using the fluorescent beam 128 attached to the end of the anti Gox Ig G 127.

On the contrary, when the temperature is set below the LCST, the PNIPAAm 123 is extended and the Gox 126 is not almost immobilized on the dendrimer 122. Therefore, the anti Gox Ig G 127 also is not almost immobilized. The fluorescent picture cannot be seen.

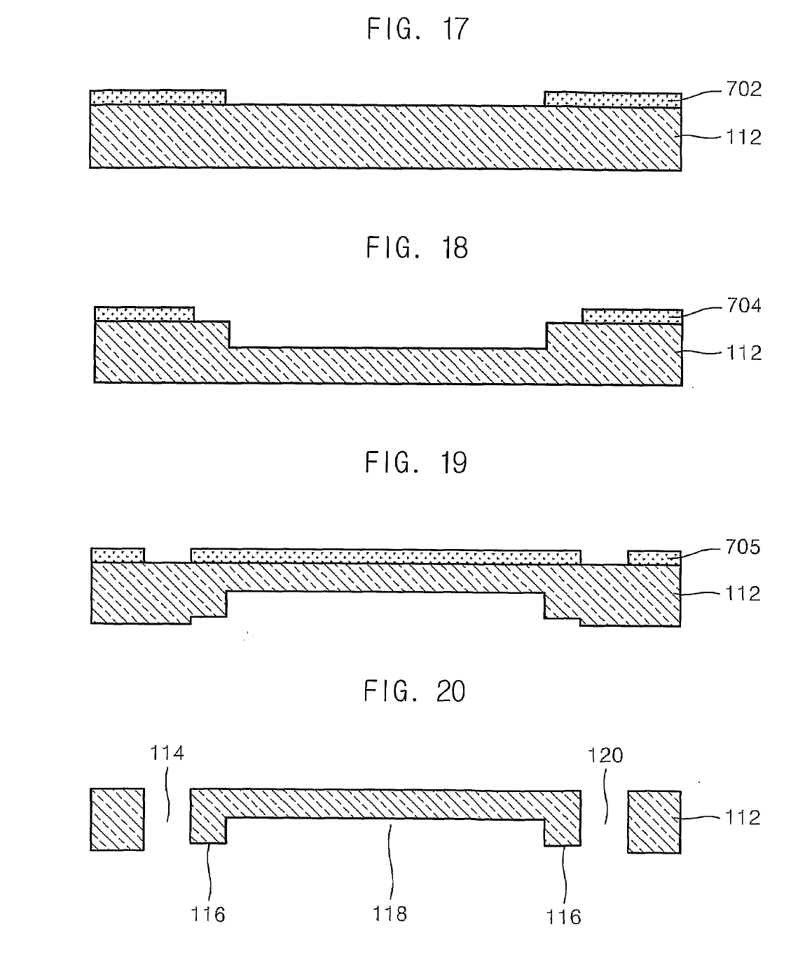

FIGS. 17 to 20 are cross-sectional views illustrating a method for manufacturing the top board of the affinity chromatography microdevice in accordance with an embodiment of the present invention. In this embodiment, a glass substrate is preferably used as the second substrate 112.

Referring to FIG. 17, a first mask 702 for the reaction chamber 118 is formed on the bottom surface of the second substrate 122. The bottom surface of the second substrate 702 is etched to a predetermined depth using the first mask 702. The first mask 702 can be coated on the bottom surface of the second substrate 112 using photoresist.

A second mask 704 for the passage 116 is formed on the bottom surface of the etched second substrate 112. The second substrate 704 is etched to a predetermined depth using the second mask 704. The passage 116 is formed narrowly. Therefore, the second substrate 112 is etched more thinly than the thickness etched in forming the reaction chamber 118. The second mask 704 can be formed by partially removing the first mask 702.

Referring to FIG. 19, a third mask 705 for the inlet 114 and the outlet 120 are formed on the second substrate 112. Using the third mask 750, the second substrate 112 is etched to be perforated. It is preferable that the third mask 705 is formed of photoresist. Through these procedures, the top board is completed.

Examples of the etching process include a sand blaster process and a laser ablation process.

FIGS. 21 to 24 are cross-sectional views illustrating a method for manufacturing the top board of the affinity chromatography microdevice in accordance with another embodiment of the present invention. In this embodiment, the top board is manufactured using molding. It is preferable to use plastic that is easily molded.

Referring to FIG. 21, a molding is manufactured which has a shape opposite to the top board. The molding 800 can be manufactured using a mechanical processing such as a numerical control machining, a silicon micromachining, or polymer micromachining.

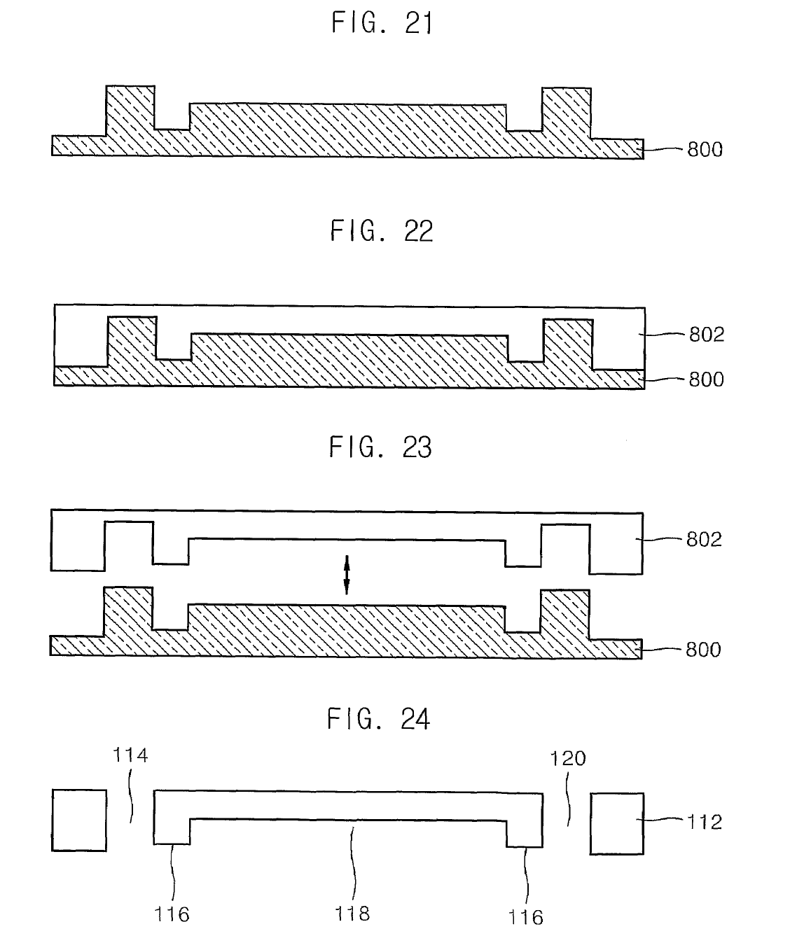

Referring to FIGS. 22 and 23, a plastic plate 802, e.g., polymethylmethacrylate (PMMA) and the molding 800 are attached using a hot embossing apparatus and molded at high temperature and high pressure. Then, the plastic plate 802 and the molding 800 are separated from each other. For the easy separation, the molding 800 may be surface-treated using organic materials, e.g., fluoro-silane.

Referring to FIG. 24, in order to form the inlet 114 and the outlet 120, the top board is etched using a chemical mechanical polishing (CMP), until its top surface is perforated. The hole can be formed using a drill, a laser processing, and a chemical etching process.

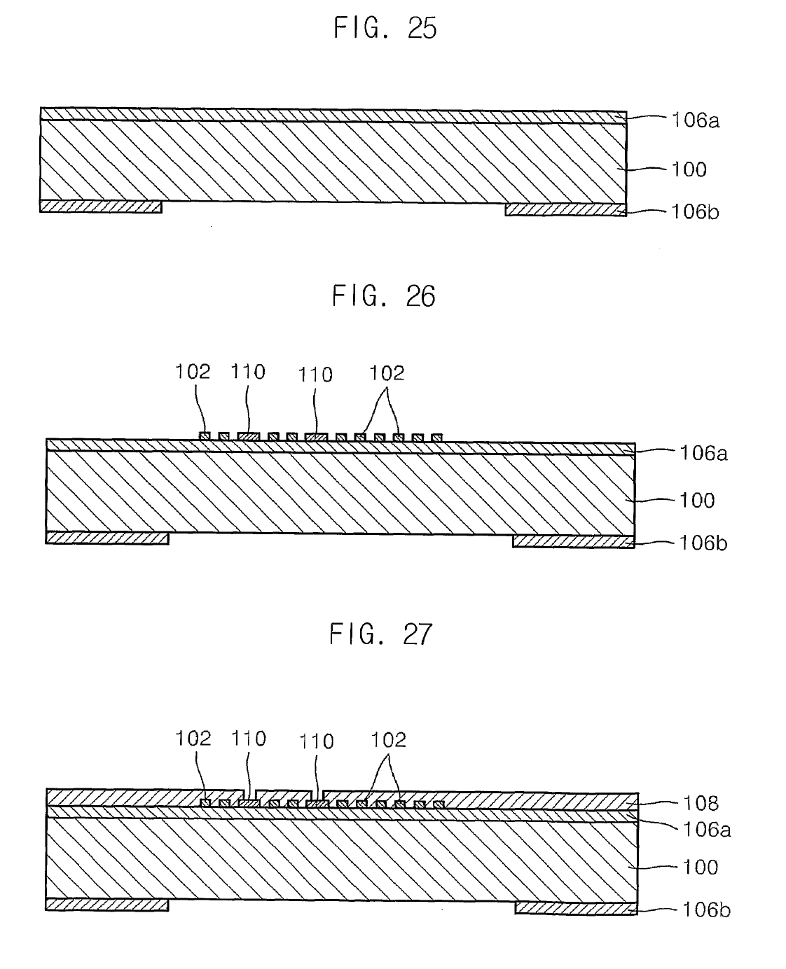

FIGS. 25 to 29 are cross-sectional views illustrating a method for manufacturing the bottom board of the affinity chromatography microdevice in accordance with an embodiment of the present invention.

Referring to FIG. 25, an insulating heating thin film 106a and an insulating layer 106b are formed on the top and bottom surfaces of the first substrate 100, respectively. The insulating heating thin film 106a is formed over the top surface of the first substrate 100, while the insulating layer 106b is formed only in a predetermined portion of the bottom surface of the first substrate 100. The insulating layer 106b is formed over the bottom surface of the first substrate 100 and a predetermined portion of the insulating layer 100 is removed using a reactive ion etching process. Preferably, the first substrate 100 is a silicon substrate, and the insulating heating thin film 106a and the insulating layer 106b are formed of silicon nitride, silicon oxide, or combination thereof.

Referring to FIG. 26, a conductive layer is deposited on the insulating heating thin film 106a and is etched using photolithography to form a heater 102, a temperature sensor 104, and a microelectrode 110. A lift-off process can also be used. The conductive layer can be formed by depositing metal, e.g., platinum, to a thickness of 0.1 to 0.5 μm. A thin film may be further formed between the insulating heating thin film 106a and the conductive layer in order for bonding and resistive contact. The thin film may be formed of titanium.

Referring to FIG. 27, an insulating layer is formed on the resulting structure and is etched using photolithography to expose the microelectrode 110. The insulating layer 108 is deposited to a thickness of 0.01 to 1 μm. The insulating layer 108 may be formed of silicon oxide in order for chemical insulation.

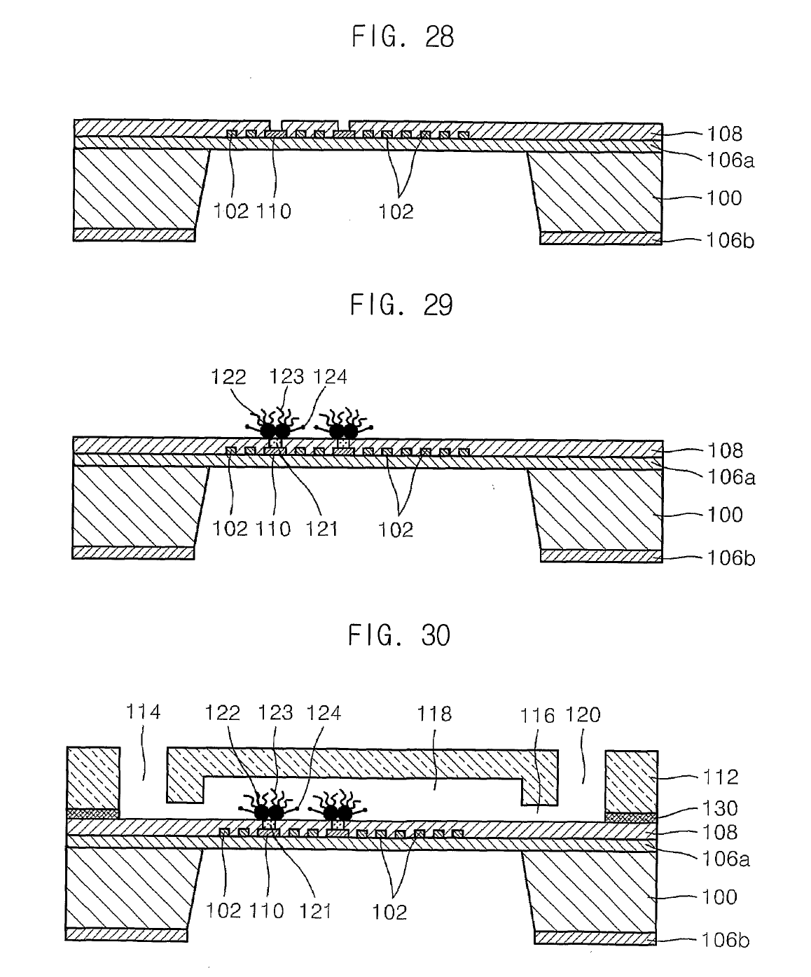

Referring to FIG. 28, the first substrate 100 where the insulating layer 106b is not formed is etched to expose the insulating heating thin film 106a. When the first substrate 100 is a silicon substrate, it can be etched using a silicon wet etching process using KOH, TMAH, and EDP or a dry etching process such as a deep reaction ion etching (RIE) process.

Referring to FIG. 29, an SAM 121, a dendrimer 122, and a PNIPAAm 123 are formed on the exposed microelectrode 110. The SAM 121, the dendrimer 122, and the PNIPAAm 123 are a surface treatment material, an immobilization material, and a thermosensitive polymer, respectively.

Specifically, the surface of the microelectrode 110 is cleaned using piranha solution or distilled water. The SAM 121 is formed by flowing 5 mM DTSP(3,3-dithiopropionic acid bis-N-hydroxysuccinimide ester), which is dissolved in DMSO, over the microelectrode 110. The DTSP can expose a reactive residue that is easily adsorbed with the surface of the microelectrode 110 and has a good reactivity with respect to amine radical existing on the molecule surface of the dendrimer 122. Thus, the DTSP is used as a reagent. A remaining reagent is removed by cleaning the microelectrode 110 using DMSO and ethanol. A dendrimer nanostructural solution (0.5%, w/w) diluted with ethanol flows over the surface activated by the SAM 121. The dendrimer nanostructure forms a covalent bond with the surface of the SAM 121 and thus is stably immobilized. Consequently, the immobilized dendrimer 122 is formed. The PNIPAAm 123 as the thermosensitive polymer is formed in the dendrimer 122. In this embodiment, PNIPAAm-NHS is used as the PNIPAAm 123. The PNIPAAm-NHS is prepared by substituting hydroxysuccinimide (NHS) for one end of the polymer. The PNIPAAm-NHS can be checked using nuclear magnetic resonance (NMR) spectrometry. It can be checked using FT-IR spectrometry that the PNIPAAm-NHS can form the surface of the thermosensitive polymer. The PNIPAAm 123 is immobilized on the dendrimer 122 by reaction between the activated surface of the dendrimer 122 and the PNIPAAm-NHS. The capture material 124 is formed on the activated surface of the remaining dendrimer 122. The capture material 124 contains amine group and can be chemically immobilized using the amine reaction radical remaining in the dendrimer 122 as the target.

Referring to FIG. 30, the affinity chromatography microdevice is manufactured by attaching the bottom board and the top board. The bottom board and the top board can be attached using liquid adhesive, powder-like adhesive, or paper-like adhesive. Also, the bottom board and the top board can be attached using UV curing adhesive, without gap or void. When it is necessary to attach the boards at room temperature or low temperature in order to prevent the deformation of biochemical material, pressure sensitive adhesive or ultrasonic bonding can be used. According to the ultrasonic bonding, the boards are partially molten using ultrasonic energy and then are attached to each other. Moreover, other attaching methods using physical shapes can also be used. It should be noted that the introduced solution must not be discharged to the outside or flow into other places through fine gap or void.

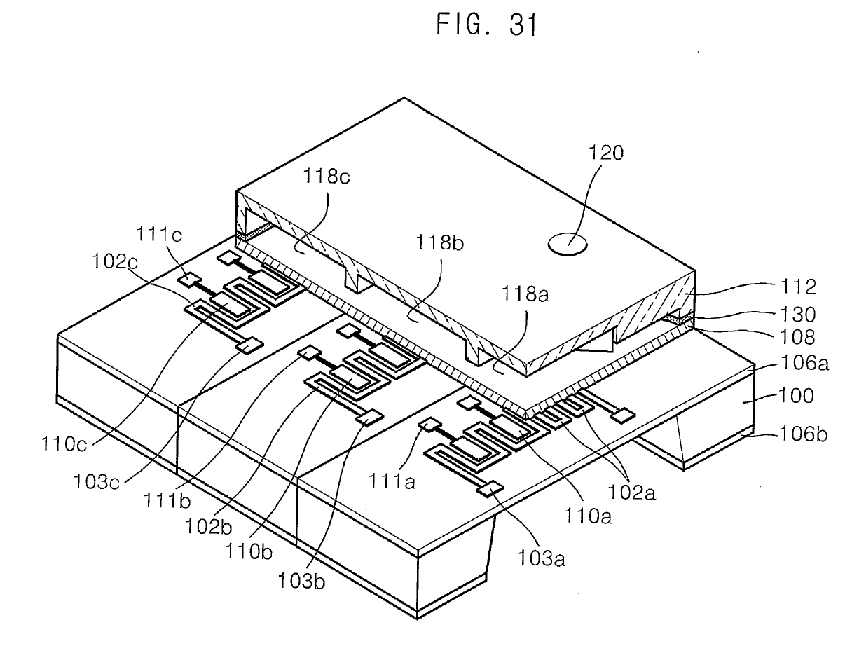

FIG. 31 is a perspective view of an affinity chromatography microdevice in accordance with another embodiment of the present invention.

Referring to FIG. 31, the affinity chromatography microdevice can separate or refine a plurality of target materials at the same time.

A top substrate of the affinity chromatography microdevice includes a plurality of reaction chambers 118A so that a plurality of capture materials can react with a plurality of target materials. Only one inlet and only one outlet are formed. The inlet and the outlet of FIG. 31 are identical to the inlet 114 and the outlet 120 of FIG. 1. Also, a passage 116 connects the inlet 114, the outlet 120, and the reaction chambers 118a, 118b and 118c.

A bottom board of the affinity chromatography microdevice includes microelectrode arrays 110a, 110b and 110c and thermosensitive polymer matrix. In the microelectrode arrays 110a, 110b and 110c, microelectrodes that can independently control temperature are arranged. The thermosensitive polymer matrix is formed on the microelectrode arrays 110a, 110b and 110c and are contracted or expanded according to the temperature change. Also, the bottom board includes heaters 102a, 102b and 102c and temperature sensors. The heaters 102a, 102b and 102c heat the reaction chambers 118a, 118b and 118c in order to independently control the temperatures of the microelectrode arrays. The temperature sensors sense the temperatures.

Further, the bottom board includes SAMs and dendrimers on the microelectrode arrays 110a, 110b and 110c. The SAMs and the dendrimers are used as the surface treatment material and the immobilization material, respectively. PNIPAAm can be used as the thermosensitive polymer matrix.

As described above, when the solution containing a plurality of target materials through the common inlet, the plurality of target materials can be separated and refined by different capture materials formed on the microelectrode arrays 110a, 110b and 110c.

In addition, the temperature can be independently controlled at the reaction chambers 118a, 118b and 118c. Therefore, the bonding of the capture materials and the target materials can be freely controlled through the temperature control. The affinity chromatography microdevice in accordance with the present invention is suitable for selectively separating and refining a plurality of biomaterials.

The present application contains subject matter related to Korean patent application No. 2005-115897 and 2006-55481, filed in the Korean Intellectual Property Office on Nov. 30, 2005, and Jun. 20, 2006, respectively, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. An affinity chromatography microdevice comprising:
a top board including an inlet and an outlet through which microfluid flows, and a reaction chamber for limiting the flow of the microfluid for reaction; and
a bottom board including a microelectrode for independently controlling a microtemperature, and a thermosensitive polymer matrix formed on the microelectrode, the thermosensitive polymer matrix being contracted or expanded according to temperature change.

2. The affinity chromatography microdevice as recited in claim 1, wherein the bottom board further includes a capture material formed on the microelectrode to capture a target material.

3. The affinity chromatography microdevice as recited in claim 2, wherein the bottom board further includes a surface treatment material on the microelectrode.

4. The affinity chromatography microdevice as recited in claim 3, wherein the bottom board further includes an immobilization material on the surface treatment material.

5. The affinity chromatography microdevice as recited in claim 1, wherein the thermosensitive polymer matrix is a poly N-isopropylacrylamide (PNIPAAm).

6. The affinity chromatography microdevice as recited in claim 3, wherein the surface treatment material is a self assembled monolayer (SAM).

7. The affinity chromatography microdevice as recited in claim 4, wherein the immobilization material is a dendrimer.

8. The affinity chromatography microdevice as recited in claim 1, wherein the bottom board further includes:
an insulating heating thin film formed by etching a predetermined rear surface of a substrate, so that the insulating heating thin film is isolated from a peripheral portion;
a heater formed on the insulating heating thin film to heat the reaction chamber;
a temperature sensor formed on the insulating heating thin film to sense the temperature of the reaction chamber;
the microelectrode formed on the insulating heating thin film; and
an insulating layer surrounding the heater and the temperature sensor.

9. The affinity chromatography microdevice as recited in claim 8, wherein the bottom board further includes a capture material formed on the microelectrode to capture a target material.

10. The affinity chromatography microdevice as recited in claim 8, wherein the substrate of the bottom board is formed of plastic.

11. The affinity chromatography microdevice as recited in claim 8, wherein the insulating heating thin film is formed of Si₃N₄, SiO₂, Si₃N₄/SiO₂/Si₃N₄, or SiO₂/Si₃N₄/SiO₂ N₄/SiO₂ and has a thickness of 0.1 to 10 μm.

12. The affinity chromatography microdevice as recited in claim 8, wherein the insulating heating thin film is formed of PMMA, PC, COC, COP, PI, PS, PVC, LCP, or PFA, and has a thickness of 0.1 to 10 μm.

13. The affinity chromatography microdevice as recited in claim 8, wherein the heater, the microelectrode array and the temperature sensor each includes:
an electrode line; and
an electrode pad connected to the electrode line and formed in an outside of th bottom board.

14. The affinity chromatography microdevice as recited in claim 8, wherein the heater and the temperature sensor include a monolayer or multilayer formed of at least one selected from the group consisting of metal, polycrystalline silicon, GaAs, polycrystalline SiGe, metal oxide, and ceramic.

15. The affinity chromatography microdevice as recited in claim 1, wherein the microelectrode is formed of gold or platinum.

16. The affinity chromatography microdevice as recited in claim 1, wherein the bottom board further includes:
an insulting heating thin film formed by etching a predetermined rear surface of a substrate so that the insulating heating thin film is isolated from a peripheral portion;
a heater formed on the insulating heating thin film to heat the reaction chamber;
a temperature sensor formed on the insulating heating thin film to sense the temperature of the reaction chamber;
a first insulting layer surrounding the heater and the temperature sensor;
the microelectrode formed on the first insulating layer; and
a second insulating layer formed on the microelectrode and the first insulating layer to partially expose a surface of the microelectrode.

17. The affinity chromatography microdevice as recited in claim 1, wherein the top board further includes a flow stopper formed at an end of the reaction chamber to stop a movement of the fluid.

18. An affinity chromatography microdevice comprising:
a top board including an inlet and an outlet through which microfluid flows, and a plurality of reaction chambers for limiting the flow of the microfluid for reaction; and
a bottom board including a microelectrode array having a plurality of microelectrode for independently controlling a micro-temperature, and a thermosensitive polymer matrix formed on the microelectrode array, the thermosensitive polymer matrix being contracted or expanded according to temperature change.

19. The affinity chromatography microdevice as recited in claim 18, wherein the bottom board further includes different capture materials formed on at least one microelectrode and another microelectrode among the plurality of microelectrodes to capture different target materials.

20. The affinity chromatography microdevice as recited in claim 18, wherein the bottom board further includes a surface treatment material on the microelectrode array.

21. The affinity chromatography microdevice as recited in claim 18, wherein the bottom board further includes an immobilization material on the surface treatment material.

22. The affinity chromatography microdevice as recited in claim 18, wherein the thermosensitive polymer matrix is a poly N-isopropylacrylamide (PNIPAAm).

23. The affinity chromatography microdevice as recited in claim 20, wherein the surface treatment material is a self assembled monolayer (SAM).

24. The affinity chromatography microdevice as recited in claim 21, wherein the immobilization material is a dendrimer.

25. The affinity chromatography microdevice as recited in claim 18, wherein the bottom board further includes:
an insulating heating thin film formed by etching a predetermined rear surface of a substrate so that the insulating heating thin film is isolated from a peripheral portion;
a plurality of heaters formed on the insulating heating thin film to heat the reaction chamber;
a plurality of temperature sensors formed on the insulating heating thin film to sense the temperature of the reaction chambers;
the microelectrode formed on the insulating heating thin film; and
an insulating layer surrounding the heaters and the temperature sensors.

26. The affinity chromatography microdevice as recited in claim 18, wherein the bottom board further includes:
an insulting heating thin film formed by etching a predetermined rear surface of a substrate, so that the insulating heating thin film is isolated from a peripheral portion;
a plurality of heaters formed on the insulating heating thin film to heat the reaction chambers;
a plurality of temperature sensors formed on the insulating heating thin film to sense the temperature of the reaction chambers;
a first insulting layer surrounding the heaters and the temperature sensors; the microelectrode formed on the first insulating layer; and
a second insulating layer formed on the microelectrode array and the first insulating layer to partially expose a surface of the microelectrode array.

27. A method for manufacturing an affinity chromatography microdevice, comprising the steps of:
a) preparing a bottom board including a microelectrode for independently controlling a micro-temperature, and a thermosensitive polymer matrix formed on the microelectrode, the thermosensitive polymer matrix being contracted or expanded according to temperature change;
b) preparing a top board including a reaction chamber, an inlet, and an outlet; and
c) attaching the bottom board to the top board.

28. The method as recited in claim 27, wherein the microelectrode is provided in plurality on the bottom board to independently control temperature, and the reaction chamber is provided in plurality.

29. The method as recited in claim 27, wherein the step a) includes the steps of:
a1) forming a self assembled monolayer (SAM) on the microelectrode by processing 3,3-dithoiopropionic acid bis-N-hydroxysuccinimide ester (DTSP);
a2) forming a dendrimer on the SAM by processing a dendrimer nanostructural solution; and
a3) forming the thermosensitive polymer matrix on the dendrimer.

30. The method as recited in claim 27, wherein the thermosensitive polymer is a poly N-isopropylacrylamide (PNIPAAm).
